(19) United States
(12) Patent Application Publication
(10) Pub. No.: US 2022/0180420 A1
(43) Pub. Date: Jun. 9, 2022

(54) INTERMEDIARY DEVICE, CONTROL DEVICE, CONTROL METHOD AND STORAGE MEDIUM

(71) Applicant: NEC Corporation, Minato-ku, Tokyo (JP)

(72) Inventors: Masafumi OYAMADA, Tokyo (JP); Keigo KIMURA, Tokyo (JP); Kunihiro TAKEOKA, Tokyo (JP)

(73) Assignee: NEC Corporation, Minato-ku, Tokyo (JP)

(21) Appl. No.: 17/442,161

(22) PCT Filed: Mar. 28, 2019
(86) PCT No.: PCT/JP2019/013761

§ 371 Date: Sep. 23, 2021

(51) Int. Cl. G06Q 30/06; G06F 16/2457

(52) U.S. Cl. CPC G06Q 30/0633; G06F 16/24578

(57) ABSTRACT

The acquisition unit 52B acquires sales request information S1, which is request information regarding a sale of data owned by a data owner, from an owner terminal 2 used by the data owner. The determination unit 53B determines whether or not there is a user who has a past record of performing a task or who is expected to perform the task, the task being subjected to a positive effect when the data is used for the task. The notification unit 54B notifies, in a case where the determination unit 53B determines that there is a user who has a past record of performing the task or who is expected to perform the task, the owner terminal 2 of candidate buyer information S2 indicating information regarding the user.

### TECHNICAL FIELD

The present invention relates to a technical field of an intermediary device, a control method and a storage medium for intermediating with respect to the purchase and sale of data.

### BACKGROUND ART

An intermediary system is known to mediate between sellers and buyers through a communication network. For example, Patent Literature 1 discloses an intermediary system configured to display to the seller the order information excluding the identification information of the buyer and thereafter display to the buyer a list of the bidding information the seller has entered in response to the order information.

### PRIOR ART DOCUMENTS

### Patent Literature

Patent Literature 1: JP 2013-41354A

### SUMMARY OF THE INVENTION

### Problem to be Solved by the Invention

In some cases, a data owner who collects and manages the data cannot appropriately utilize its owned data. Such data can be data needed for others. On the other hand, although the buyer informs the intermediary device of the ordering information specifying the target to be purchased by the buyer according to Patent Literature 1, Patent Literature 1 is silent on the approach for mediation in such a case that seller informs the intermediary device of the target to be sold or a case that other than the service is the target of deal.

In view of the above-described issues, it is therefore an example object of the present disclosure to provide an intermediary device, a control method and a storage medium capable of suitably mediating the selection of the buyer of the data owned by the data owner.

### Means for Solving the Problem

One mode of the intermediary device is an intermediary device including: an acquisition unit configured to acquire a request information regarding a sale of data owned by a data owner from an owner terminal used by the data owner; a determination unit configured to determine whether or not there is a user who has a past record of performing a task or who is expected to perform the task, the task being subjected to a positive effect when the data is used for the task; and a notification unit configured to notify, in a case where the determination unit determines that there is the user, the owner terminal of information regarding the user.

One mode of the control method is a control method executed by an intermediary device, the control method including: acquiring a request information regarding a sale of data owned by a data owner from an owner terminal used by the data owner; determining whether or not there is a user who has a past record of performing a task or who is expected to perform the task, the task being subjected to a positive effect when the data is used for the task; and notifying, in a case where it is determined that there is the user, the owner terminal of information regarding the user.

One mode of the storage medium is a storage medium storing a program executed by a computer, the program causing the computer to function as: an acquisition unit configured to acquire a request information regarding a sale of data owned by a data owner from an owner terminal used by the data owner; a determination unit configured to determine whether or not there is a user who has a past record of performing a task or who is expected to perform the task, the task being subjected to a positive effect when the data is used for the task; and a notification unit configured to notify, in a case where the determination unit determines that there is the user, the owner terminal of information regarding the user.

### Effect of the Invention

An example advantage according to the present invention is to suitably inform the data owner of information regarding a user expected to demand the data in a case where there is a request regarding the sale of data owned by the data owner.

### BRIEF DESCRIPTION OF THE DRAWINGS

FIG. 1 illustrates a configuration of a data market system according to a first example embodiment.

FIG. 2 illustrates a schematic configuration of an intermediary device.

FIG. 3 illustrates a schematic configuration of an owner terminal used by a data owner.

FIG. 4 illustrates a schematic configuration of a user terminal used by a user.

FIG. 5 illustrates an example of a data structure of sales target data information.

FIG. 6 illustrates an example of a data structure of past record information.

FIG. 7 illustrates an example of a functional block of the intermediary device.

FIG. 8 illustrates a display example of a proposed buyers view.

FIG. 9 is an example of a flowchart according to the first example embodiment.

FIG. 10 illustrates a functional block diagram of the intermediary device according to a second example embodiment.

FIG. 11 illustrates an example of a data structure of user information according to the second example embodiment.

FIG. 12 is an example of a flowchart according to the second example embodiment.

FIG. 13 is an example of a process A in the flowchart according to the second example embodiment.

FIG. 14 illustrates a functional block diagram of the intermediary device according to a third example embodiment.

### DESCRIPTION OF EXAMPLE EMBODIMENTS

Hereinafter, with reference to the drawings, example embodiments relating to an intermediary device, a control method and a storage medium will be described.

### First Example Embodiment

(1-1) Configuration of Data Market System

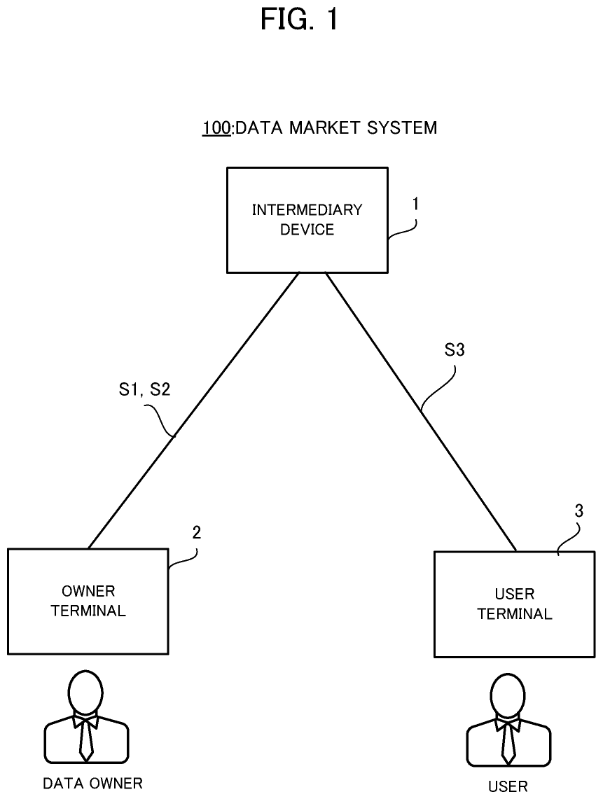

FIG. 1 illustrates a configuration of a data market system 100 according to the first example embodiment. The data market system 100 mainly includes an intermediary device 1, an owner terminal 2 used by a data owner wishing to sell its own data, and a user terminal 3 used by a user of the data market system 100. Data communication via a communication network or the like is performed between the intermediary device 1 and the owner terminal 2 and between the intermediary device 1 and the user terminal 3, respectively. Though there are only present one owner terminal 2 and one user terminal 3 in FIG. 1, a plurality of owner terminals 2 and a plurality of user terminals 3 may be present, respectively. In addition, the terms “data owner” and “user” shall include not only individuals but also organizations such as companies.

The intermediary device 1 performs processing relating to the mediation of the purchase and sale of data. Specifically, when the intermediary device 1 receives request information (also referred to as “sales request information S1”) relating to the sale of data from the owner terminal 2, the intermediary device 1 selects a user, which is presumed to demand the data, as a candidate buyer for the data. Hereafter, the data designated as the target of sale by the sales request information S1 is referred to as the “sales target data.” Then, the intermediary device 1 transmits information (also referred to as “candidate buyer information S2”) relating to the candidate buyer(s) of the sales target data to the owner terminal 2 as a response to the sales request information S1.

Further, after the transmission of the candidate buyer information S2, when the intermediary device 1 receives information specifying one of the candidate buyers from the owner terminal 2, the intermediary device 1 transmits information (also referred to as “purchase offering information S3”) for offering the user terminal 3 corresponding to the specified candidate buyer to buy the sales target data.

When the sales contract is made between the data owner and the user through an agreement of various purchase conditions relating to the sales target data, the intermediary device 1 transmits the sales target data to the user terminal 3 which the user uses. In this case, the intermediary device 1 processes the money transaction in connection with the trade of the sales target data between the data owner and the user.

The owner terminal 2 generates the sales request information S1 relating to the sales target data specified by the data owner, and transmits the sales request information S1 to the intermediary device 1. The sales request information S1 may include the sales target data itself or may include information (i.e., metadata) for specifying the sales target data in place of the sales target data itself. Further, when receiving the candidate buyer information S2 from the intermediary device 1 as a response of the sales request information S1, the owner terminal 2 displays information based on the candidate buyer information S2. The display example based on the candidate buyer information S2 will be described later.

The user terminal 3 is a terminal device used by a user of the data market system 100. For example, the user of the data market system 100 may be a person who has a trade record of data in the data market system 100 or may be a person who has performed the user registration in the data market system 100 regarding the communication address of the user terminal 3 and the user's attribute information, for example.

When the user terminal 3 receives the purchase offering information S3 from the intermediary device 1, the user terminal 3 displays a screen (view) for offering the purchase of the sales target data based on the purchase offering information S3. In this case, the user using the user terminal 3 considers whether or not the sales target data presented on the above screen is essential data for performing a task to be executed or data necessary for improving the accuracy of the task and the like. For example, the term “task” described above herein indicates process relating to any of various data analyses such as a demand analysis of commodities and an analysis of cancellation of insurance products. Then, the user terminal 3 receives various inputs regarding the purchase of the sales target data on the above-described screen and transmits the input information to the intermediary device 1.

(1-2) Device Configuration

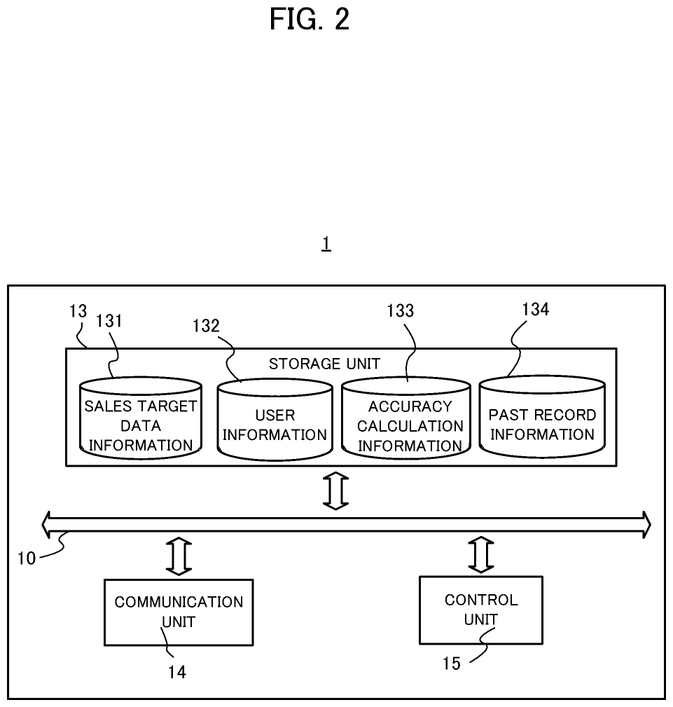

Next, each configuration of the intermediary device 1, the owner terminal 2 and the user terminal 3 will be described with reference to FIGS. 2 to 4.

FIG. 2 illustrates a schematic configuration of the intermediary device 1. The intermediary device 1 mainly includes a storage unit 13, a communication unit 14 for performing data communication and a control unit 15.

The control unit 15 includes a CPU, a ROM and a RAM which are not shown and performs various controls for each component in the intermediary device 1. The control unit 15 functions as a computer for executing a program. The process which the control unit 15 executes will be described later.

The storage unit 13 is configured by memories such as a hard disk and a flash memory. The storage unit 13 stores a program to be executed by the control unit 15 and the information necessary for the control unit 15 to execute a predetermined process by executing a program. The above-described program may be stored in any storage medium other than the storage unit 13.

Further, the storage unit 13 stores, for example, sales target data information 131, user information 132, accuracy calculation information 133 and past record information 134.

The sales target data information 131 is information regarding the sales target data and it is generated based on the sales request information S1 received from the owner terminal 2.

The user information 132 is information regarding users which use the data market system 100 and it is generated based on the information registered by the user at the time of user registration or in the past trade or the like, for example. For example, the user information 132 includes identification information representing the user, contact information indicative of a contact address and the like of the user. The user information 132 may also further include information such as past usage records of the user in the data market system 100.

The accuracy calculation information 133 is the information necessary for calculation of the accuracy of the task. For example, the accuracy calculation information 133 may be a correspondence table or the like that indicates the correspondence, with respect to each task subjected to calculation of the accuracy, between each candidate of the combination of data to be used for the each target task and the accuracy when the each candidate of the combination is used.

The past record information 134 indicates the past records with respect to past trades (transactions) established in the data market system 100. The details of the past record information 134 will be described later.

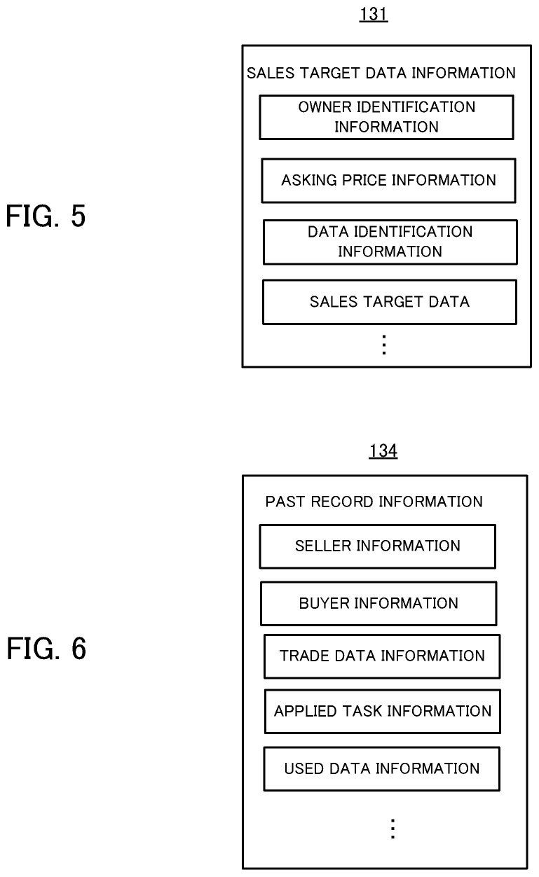

Here, an example of each data structure of the sales target data information 131 and the past record information 134 will be described with reference to FIGS. 5 and 6.

FIG. 5 is an example of a data structure of the selling target data information 131. For example, the sales target data information 131 is information generated for each sales request information S1 received from the owner terminal 2, and includes the owner identification information, the asking price information, the data identification information and the sales target data.

The “OWNER IDENTIFICATION INFORMATION” is information for identifying the owner (i.e., data owner using the owner terminal 2) of the sales target data. The owner identification information may include information regarding the attributes of the data owner such as the company name and the industry type. The “ASKING PRICE INFORMATION” is information indicating the asking price set by the data owner. The “DATA IDENTIFICATION INFORMATION” is information (metadata) for identifying the sales target data, and includes information indicating various attributes of the sales target data such as the name of the sales target data, the data size thereof and the like. The “SALES TARGET DATA” is raw data of the sales target data.

The data structure of the sales target data 131 is not limited to the example shown in FIG. 5. For example, the sales target data information 131 may not include the “SALES TARGET DATA”. In this case, for example, when the sales contract of the sales target data is made between the data owner and the user, the owner terminal 2 may directly transmit the sales target data to the user terminal 3.

FIG. 6 is an example of the data structure of the past record information 134. For example, the past record information 134 is generated for each trade (sales contract) established in the data market system 100. For example, the past record information includes seller information, buyer information, trade data information, applied task information and used data information. Here, the seller information includes the identification information of the user (data owner) who sold data in the target trade. The buyer information includes the identification information of the users who bought in the target trade. The trade data information includes the identification information representing the data subjected to the target trade. The applied task information indicates the task that was performed by the buyer by use of the data indicated by the trade data information. The used data information indicates the identification information for identifying the data that was used when the buyer executed the task indicated by the applied task information.

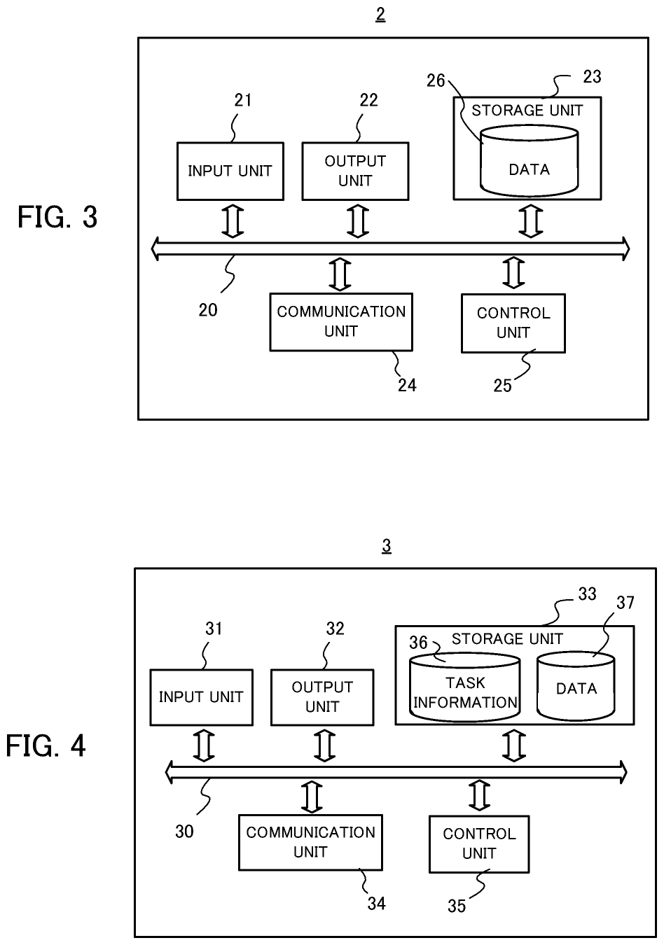

FIG. 3 illustrates a schematic configuration of the owner terminal 2. The owner terminal 2 mainly includes an input unit 21, an output unit 22, a storage unit 23, a communication unit 24 for performing data communication and a control unit 25. Each of these elements is connected to each other via a bus line 20.

The input unit 21 is an interface that accepts an input of a user, and corresponds to a touch panel, a button and/or a voice input device, for example. The output unit 22 is an interface for outputting information to the user and corresponds to a display for displaying information and/or a speaker for outputting sound.

The storage unit 23 is configured by memories such as a hard disk and a flash memory. The storage unit 23 stores a program to be executed by the control unit 25, and the information necessary for the control unit 25 to execute a predetermined process by executing a program. The storage unit 23 stores the data 26 including the sales target data.

The control unit 25 includes a CPU, a ROM and a RAM which are not shown, and performs various controls for each component in the owner terminal 2. For example, the control unit 25 generates the sales request information S1 relating to the data specified by the input unit 21 and transmits the sales request information S1 to the intermediary device 1 through the communication unit 24. Further, when receiving the candidate buyer information S2 from the intermediary device 1 via the communication unit 24, the control unit 25 displays information based on the candidate buyer information S2 by controlling the output unit 22.

FIG. 4 illustrates a schematic configuration of the user terminal 3. The user terminal 3 mainly includes an input unit 31, an output unit 32, a storage unit 33, a communication unit 34 for performing data communication and a control unit 35. Each of these elements is connected to each other via a bus line 30.

The input unit 31 is an interface that accepts an input by a user, and corresponds to, for example, a touch panel, a button and/or a voice input device. The output unit 32 is an interface for outputting information to the user and corresponds to, for example, a display for displaying information and/or a speaker for outputting sound.

The storage unit 33 is configured by memories such as a hard disk and a flash memory. The storage unit 33 stores a program to be executed by the control unit 35 and information necessary for the control unit 35 to execute a predetermined process by executing a program. The storage unit 33 stores task information 36 and data 37. The task information 36 is information necessary for performing task(s) by a user using the user terminal 3, and includes, for example, an execution program of the task(s) such as an analysis engine or an analysis script. The data 37 is the data to be analyzed by the task(s) described above.

The control unit 35 includes a CPU, a ROM and a RAM which are not shown, and performs various controls for each component in the user terminal 3. For example, when receiving the purchase offering information S3 via the communication unit 34, the control unit 35 outputs information by controlling the output unit 32 based on the purchase offering information S3.

(1-3) Functional Block

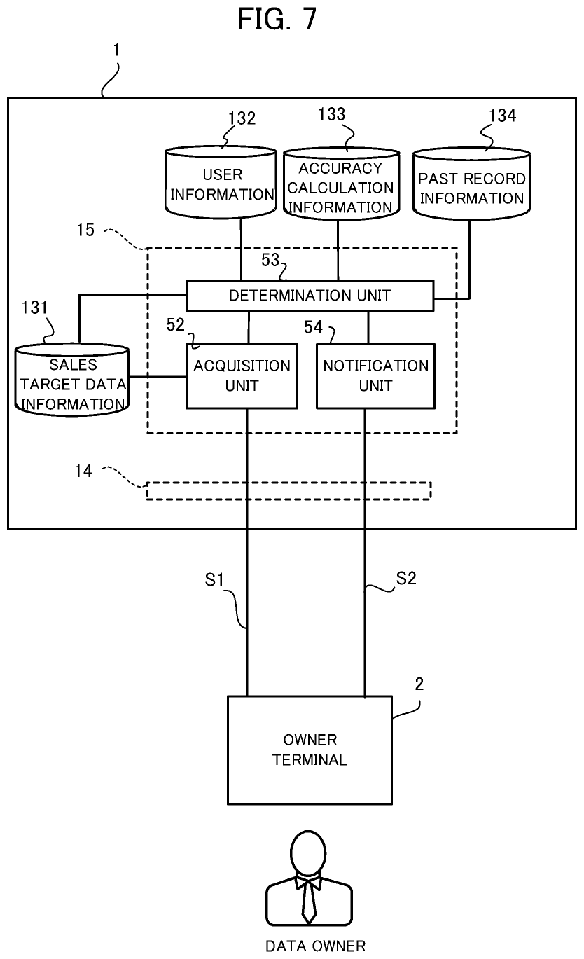

FIG. 7 illustrates an example of a functional block of the intermediary device 1 regarding the reception of the sales request information S1 and the transmission of the candidate buyer information S2. The control unit 15 of the intermediary device 1 functionally includes an acquisition unit 52, a determination unit 53 and a notification unit 54.

The acquisition unit 52 receives the sales request information S1 via the communication unit 14 from the owner terminal 2. The acquisition unit 52 generates the sales target data information 131 based on the received sales request information S1, and stores the generated sales target data information 131 in the storage unit 13.

The determination unit 53 refers to the sales target data information 131 generated from the sales request information S1 acquired by the acquisition unit 52, the user information 132, the accuracy calculation information 133 and the past record information 134, and determines whether or not there is a candidate buyer for the sales target data corresponding to the sales request information S1.

Specifically, first, the determination unit 53 calculates the increase in the accuracy to be made on the assumption that the sales target data is additionally used for a task (also referred to simply as “past record task”) indicated by the applied task information of the past record information 134. The term “increase in the accuracy” described above herein indicates the difference between the accuracy to be made on the assumption that the sales target data is not additionally used for the past record task and the accuracy to be made on the assumption that the sales target data is additionally used for the past record task. For example, the determination unit 53 refers to the accuracy calculation information 133 and calculates the accuracy when (on the assumption that) only the data (that is, the data used when the past record task was performed in the past) indicated by the used data information of the actual past record information 134 is used for the past record task. Further, the determination unit 53 refers to the accuracy calculation information 133 and calculates the accuracy when (on the assumption that) both the data indicated by the used data information and the sales target data are used for the past record task. Then, the determination unit 53 calculates the difference between these calculated accuracies as the above-described “increase in the accuracy”.

Next, when the increase in the accuracy of the past record task is equal to or larger than a threshold value at the time of adding the sales target data, the determination unit 53 considers that the sales target data is effective for the past record task and determines that the user corresponding to the past record task is a candidate buyer. The above-described threshold value may be set to a predetermined value or may be set to a value so that the number of the candidate buyers is a predetermined number. Then, the determination unit 53 supplies the notification unit 54 with the user information 132 corresponding to the candidate buyer(s), the past record information 134, and information indicative of the accuracy calculated by the determination unit 53 and the like.

The notification unit 54 generates the candidate buyer information S2 relating to the user whom the determination unit 53 regards as the candidate buyer, and transmits the candidate buyer information S2 to the owner terminal 2 via the communication unit 14. In this case, the notification unit 54 generates the display information regarding a view (also referred to as the “proposed buyers view”) for proposing the buyer of the sales target data based on: the user information 132; the past record information 134; and the information indicative of the accuracy calculated by the determination unit 53. Then, the notification unit 54 transmits the generated display information to the owner terminal 2 as the candidate buyer information S2. An example of the display of the proposed buyers view will be described later. It is noted that when the notification unit 54 receives the determination information indicating that there is no corresponding candidate buyer from the determination unit 53, the notification unit 54 transmits to the owner terminal 2 the display information for displaying the information indicating that there is no candidate buyer as the candidate buyer information S2.

(1-4) Display Example

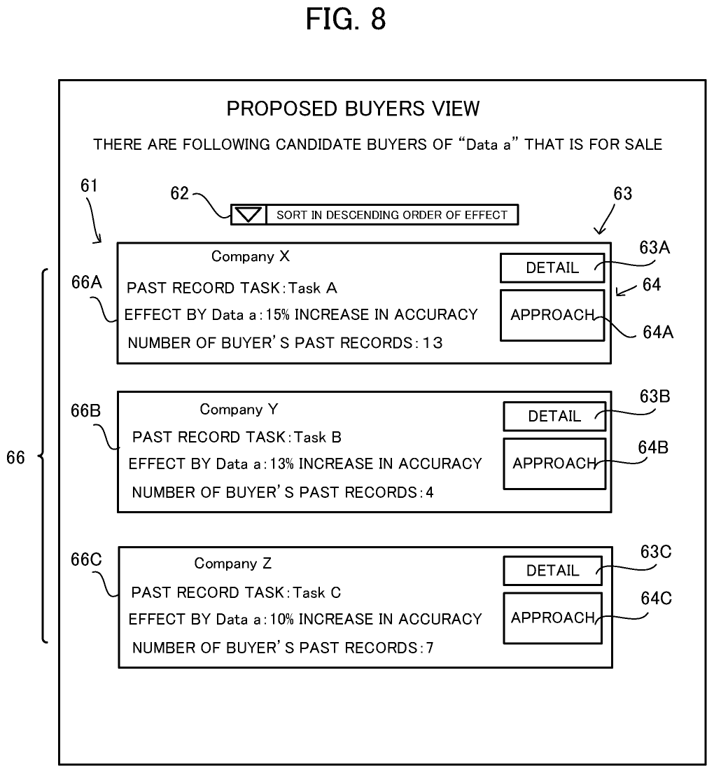

FIG. 8 is a display example of a proposed buyers view displayed by the owner terminal 2 based on the candidate buyer information S2. As shown in FIG. 8, the notification unit 54 of the intermediary device 1 displays the candidate buyer list 61 and the sort selection field 62 on the proposed buyers view. FIG. 8 shows, as an example, an example of a display of a proposed buyers view when the sales target data is “Data a”.

The candidate buyers list 61 includes the candidate buyer display fields 66 (66A to 66C) each showing the information for each candidate buyer. The candidate buyer display field 66 is a display field showing information for each candidate buyer. Here, on the candidate buyer display field 66A, the notification unit 54 displays the information regarding the candidate buyer “Company X” having a record of performing the past record task “Task A”. Similarly, the notification unit 54 displays the information regarding the candidate buyer “Company Y” having a record of performing the past record task “Task B” on the candidate buyer display field 66B, and displays the information regarding the candidate buyer “Company Z” having a record of performing the past record task “Task C” on the candidate buyer display field 66C.

Here, each candidate buyer display field 66 include a display area for the items “PAST RECORD TASK”, “EFFECT BY Data a” and “NUMBER OF BUYER'S PAST RECORDS”, a detail button 63 (63A to 63C) and an approach instruction button 64 (64A to 64C).

The notification unit 54 displays, as “PAST RECORD TASK” in the candidate buyer display field 66, a past record task on which there is a positive effect (that is, the accuracy is improved) by using the sales target data “Data a” and which is selected from past record tasks of the candidate buyer. Further, the notification unit 54 displays, as “EFFECT BY Data a”, the increased ratio in the accuracy obtained by additionally using the sales target data “Data a” for the past record task. In addition, on the basis of the user information 132 or past record information 134, the notification unit 54 displays, as “NUMBER OF BUYER'S PAST RECORDS”, the number of times that the corresponding candidate buyer became a buyer in the data market system 100 in the past.

The detail button 63 is a button for instructing the display of detailed information regarding the corresponding candidate buyer. When detecting the selection of the detailed button 63, the notification unit 54 transmits the display information for displaying a view of the detailed information regarding the corresponding candidate buyer to the owner terminal 2. Examples of the detailed information described above may include: information regarding the evaluation from the other party when the buyer traded the data using the data market system 100 in the past; and general profile information such as the size of the company and information regarding whether or not the candidate buyer is a listed company in a case where the candidate buyer is a company.

The approach instruction button 64 is a button for instructing to offer the corresponding candidate buyer to buy the sales target data “Data a”. When detecting the selection of the approach instruction button 64, the notification unit 54 transmits the purchase offering information S3 relating to the sales target data “Data a” to the user terminal 3 of the target candidate buyer. In this case, for example, on the basis of the sales target data information 131 and the user information 132, the notification unit 54 includes information regarding the asking price of the sales target data “Data a” and information regarding the data owner of the “Data a” in the purchase offering information S3.

The sort selection field 62 is a selection field for specifying the order of the candidate buyer display fields 66A to 66C in the candidate buyer list 61. Here, as an example, the sort selection field 61 is a pull-down menu selection field, and the item “SORT IN DESCENDING ORDER OF EFFECT” is selected therein in FIG. 8. Then, in this case, the notification unit 54 arranges and displays the candidate buyers display field 66A to 66C in descending order of the increased ratio of the accuracy indicated by the “EFFECT BY Data a”. It is noted that selection items of the sort selection field 61 include at least a selection item “SORT DESCENDING ORDER OF NUMBER OF BUYER'S PAST RECORDS” in addition to the selection item “SORT IN DESCENDING ORDER OF EFFECT”. When the selection item “SORT DESCENDING ORDER OF NUMBER OF BUYER'S PAST RECORDS” is selected, the notification unit 54 arranges and displays the candidate buyer display fields 66A to 66C in descending order of the number indicated by “NUMBER OF BUYER'S PAST RECORDS” in the candidate buyer display fields 66A to 66C.

(1-5) Processing Flow

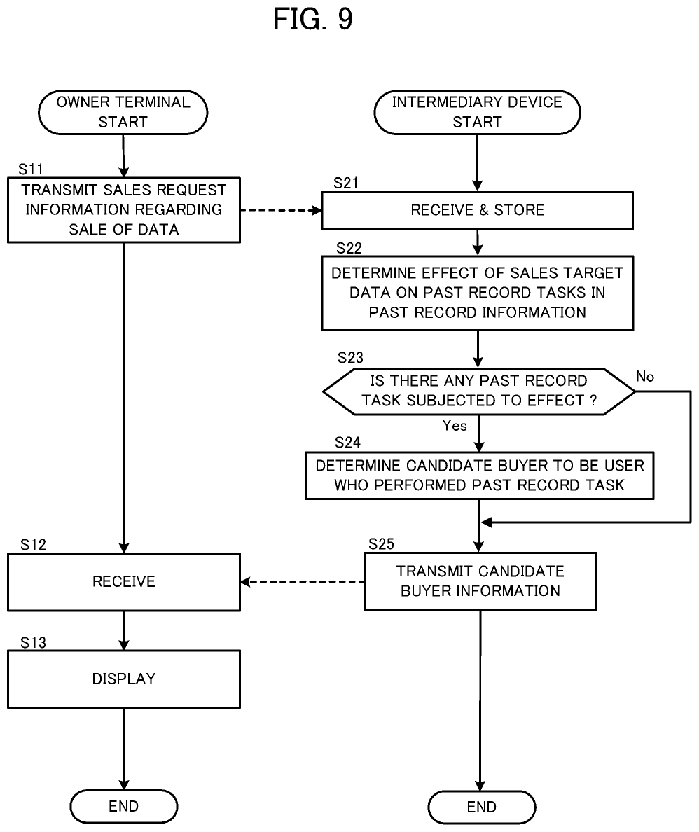

FIG. 9 is an example of a flowchart showing the processing procedure executed by the intermediary device 1 and the owner terminal 2 according to the first example embodiment.

First, when the owner terminal 2 detects the input relating to the sale of the sales target data by the input unit 21, the owner terminal 2 generates the sales request information S1 regarding the sale of the designated sales target data and transmits the sales request information S1 to the intermediary device 1 (step S11).

The acquisition unit 52 of the intermediary device 1 receives the sales request information S1 from the owner terminal 2 and stores the sales target data information 131 based on the sales request information S1 (step S21). Then, the determination unit 53 of the intermediary device 1 determines the effect of the sales target data on each of the past record tasks recorded in the past record information 134 (step S22). In this case, the determination unit 53 refers to the accuracy calculation information 133 and calculates the difference between the accuracy in a case where the sales target data is used and the accuracy in a case where the sales target data is not used for each of the past record tasks recorded in the past record information 134. Then, for example, when the difference described above for a past record task is equal to or larger than a predetermined value, the determination unit 53 determines that there is a positive effect (effectiveness) of the sales target data on the past record task.

If there is any past record task subjected to the positive effect (step S23: YES), the determination unit 53 refers to the past record information 134 and determines that the user who performed the past record task is a candidate buyer (step S24). Then, the notification unit 54 transmits the candidate buyer information S2 regarding the candidate buyer determined by the determination unit 53 to the owner terminal 2 (step S25). The candidate buyer information S2 includes the display information regarding the proposed buyers view.

On the other hand, if there is no past record task subjected to the positive effect (step S23; NO), the intermediary device 1 determines that there are no candidate buyer. In this case, the intermediary device 1 generates the candidate buyer information S2 including the display information indicating that there is no candidate buyer, and transmits the candidate buyer information S2 to the owner terminal 2 (step S25).

The owner terminal 2 receives the candidate buyer information S2 as a response of the sales request information S1 from the intermediary device 1 after the transmission of the sales request information S1 at step S11 (step S12). Then, on the basis of the received candidate buyer information S2, the owner terminal 2 displays the proposed buyers view or the like by the output unit 22 (step S13).

Thus, according to the first example embodiment, in such a case that the intermediary device 1 receives the sales request information S1, which specifies the sales target data, from the owner terminal 2, the intermediary device 1 selects, from the past users, candidate buyer(s) to be expected to demand the sales target data thereby to notify the owner terminal 2 of the candidate buyer(s). This allows the data owner to suitably select the buyer of the sales target data. Further, by including information regarding the effect of the sales target data in the information regarding the candidate buyer(s) to be displayed on the owner terminal 2, the intermediary device 1 can suitably support the data owner to select the sales target data.

### Second Example Embodiment

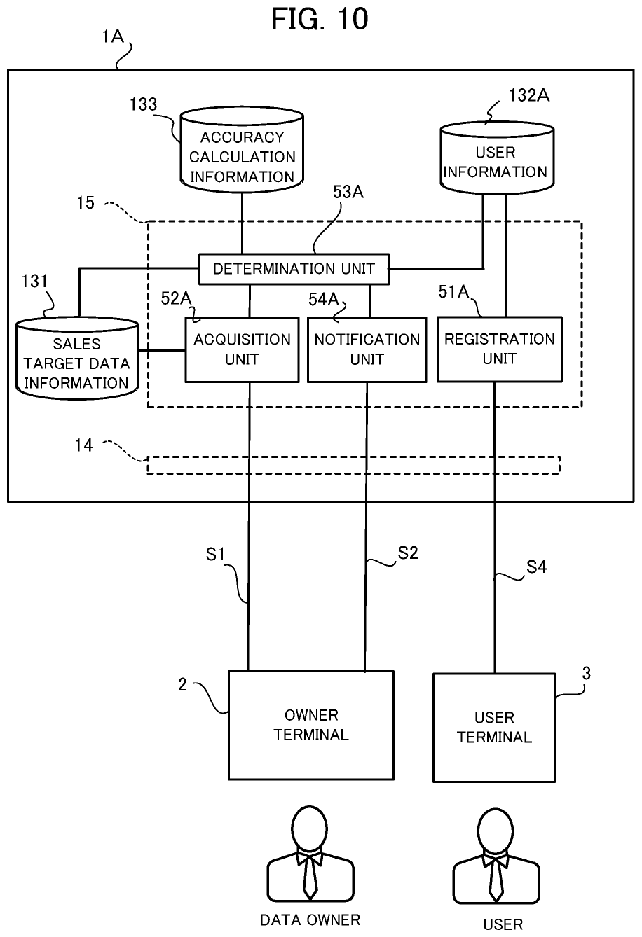

FIG. 10 illustrates a functional block diagram of the intermediary device 1A according to the second example embodiment. The intermediary device 1A according to the second example embodiment determines the candidate buyers based on the effect (effectiveness) of the sales target data on tasks which is recorded in the user information 132A and which is planned to be performed, instead of determining the candidate buyers based on the effect of the sales target data on the past record tasks recorded in the past record information 134.

The control unit 15 of the intermediary device 1A according to the second example embodiment functionally includes a registration unit 51A, an acquisition unit 52A, a determination unit 53A and a notification unit 54A. The intermediary device 1A also including user information 132A that includes information regarding tasks planned to be performed by users.

When the registration unit 51A receives from the user terminal 3 registration information “S4” including information regarding a task (also referred to as the “planned task”) that is expected (planned) to be performed, the registration unit 51A generates the user information 132A based on the registration information S4 and stores the user information 132A in the storage unit 13.

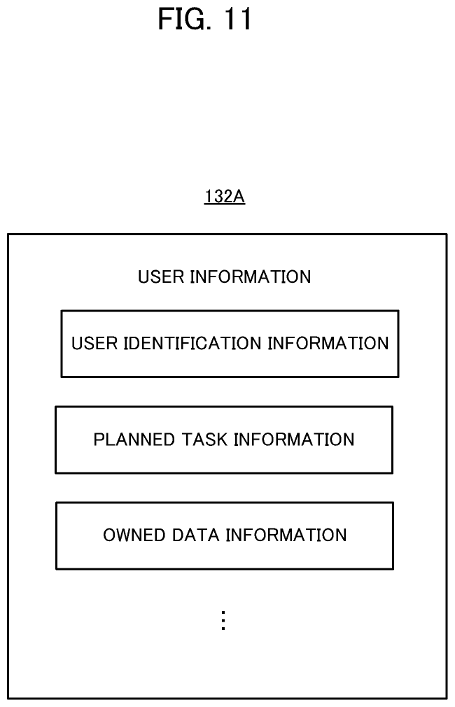

FIG. 11 is an example of the data structure of the user information 132A. The user information 132A shown in FIG. 11 mainly includes user identification information, planned task information and owned data information.

The “USER IDENTIFICATION INFORMATION” is the identification information representing a user. The “PLANNED TASK INFORMATION” is information regarding a task planned to be performed by the user. The “OWNED DATA INFORMATION” refers to information regarding the data owned by the user. For example, by receiving the registration information S4 including the user identification information, the planned task information and the owned data information from the user terminal 3, the registration unit 51A generates the user information 132A with the data structure shown in FIG. 11.

With reference again to FIG. 10, a description will be given of the functional configuration of the intermediary device 1A. In the same way as the acquisition unit 52 of the first example embodiment, the acquisition unit 52A receives the sales request information S1 from the owner terminal 2 and stores the sales target data information 131 based on the sales request information S1.

The determination unit 53A refers to the planned task information and the owned data information of the user information 132A generated for each user, and calculates the effect (effectiveness) of the sales target data on the planned task indicated by the planned task information. Specifically, the determination unit 53A calculates, as the above-described effect, the difference between the accuracy to be made on the assumption that only the data indicated by the corresponding owned data information is used for the planned task and the accuracy to be made on the assumption that both of the data indicated by the owned data information and the sales target data are used for the planned task. Then, the determination unit 53A determines that the user corresponding to the planned task for which the above difference in accuracy is equal to or larger than a predetermined value is a candidate buyer.

The notification unit 54A, as with the notification unit 54 of the first example embodiment, generates candidate buyer information S2 relating to the user whom is regarded by the determination unit 53 as a candidate buyer, and transmits the candidate buyer information S2 to the owner terminal 2 via the communication unit 14.

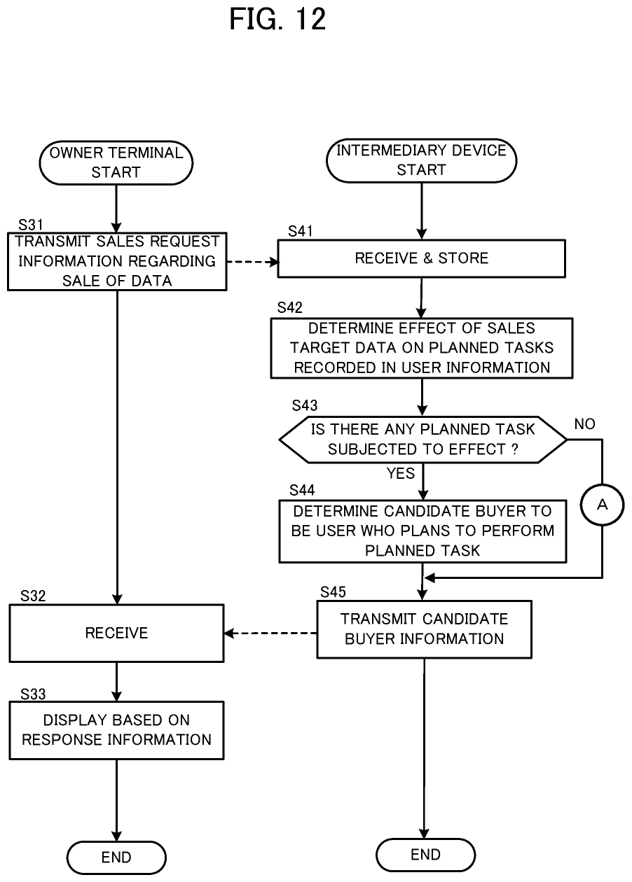

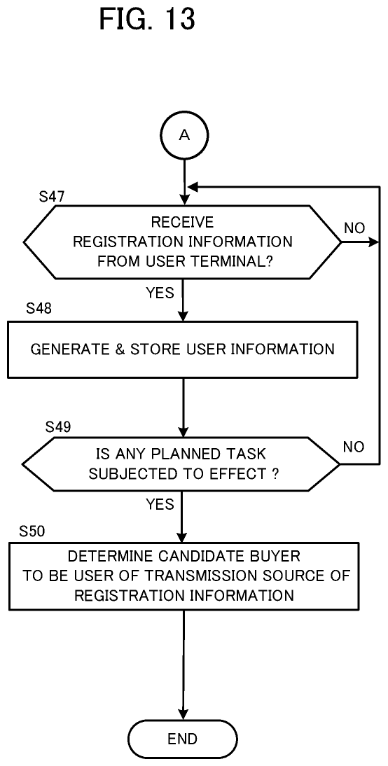

FIGS. 12 and 13 are examples of flowcharts showing the processing procedure of the intermediary device 1 and the owner terminal 2 according to the second example embodiment.

First, when the owner terminal 2 detects the input relating to the sale of the sales target data by the input unit 21, the owner terminal 2 generates the sales request information S1 regarding the sale of the designated sales target data, and transmits the sales request information S1 to the intermediary device 1 (step S31).

The acquisition unit 52A of the intermediary device 1 receives the sales request information S1 from the owner terminal 2, and stores the sales target data information 131 generated based on the sales request information S1 (step S41). When receiving the registration information S4 from the user terminal 3, the registration unit 51A stores the user information 132A generated based on the received registration information S4 in the storage unit 13.

Then, the determination unit 53A of the intermediary device 1 determines the effect (effectiveness) of the sales target data for the planned task recorded in the user information 132A (step S42). In this case, for example, when the difference between the accuracy in a case where only the data owned by the target user is used for the planned task and the accuracy in a case where both the data owned by the target user and the sales target data are used for the planned task is equal to or larger than a predetermined value, the determination unit 53A determines that there is a positive effect of the sales target data on the planned task. In another example, the determination unit 53A determines that there is a positive effect of the sales target data on the planned task in a case that using the sales target data for the planned task is essential to perform the planned task.

When there is a planned task subjected to the positive effect (step S43; YES), the determination unit 53A determines a candidate buyer to be the user who plans to perform the planned task subjected to the positive effect. Then, the notification unit 54A transmits the candidate buyer information S2 regarding the candidate buyer determined by the determination unit 53A to the owner terminal 2 (step S45). Here, the candidate buyer information S2 includes the display information for displaying the proposed buyers view.

On the other hand, when there is no planned task subjected to the positive effect (step S43; NO), the intermediary device 1 executes the later-described process A shown in FIG. 13.

After the transmission of the sales request information S1 at step S11, the owner terminal 2 receives the candidate buyer information S2 from the intermediary device 1 as a response of the sales request information S1 (step S32). Then, the owner terminal 2 displays the proposed buyers view or the like by the output unit 22 on the basis of the received candidate buyer information S2 (step S33).

Here, the process A will be described with reference to FIG. 13.

The registration unit 51A of the intermediary device 1 determines whether or not it has received the registration information S4 from the user terminal 3 (step S47). When the registration unit 51A has received the registration information S4 from the user terminal 3 (step S47; YES), the registration unit 51A stores the user information 132A generated based on the registration information S4 in the storage unit 13 (step S48). On the basis of the user information 132A generated at step S48 and the accuracy calculation information 133, the determination unit 53A determines whether or not there is a planned task subjected to the positive effect by using the sales target data (step S49). When there is a planned task subjected to the positive effect by using the sales target data (step S49: YES), the determination unit 53A determines that the user of the transmission source of the registration information S4 is a candidate buyer (step S50). Then, the notification unit 54A proceeds to the process at step S45 in FIG. 12. In this case, at step S45, the notification unit 54A transmits the candidate buyer information S2 relating to the user regarded as a candidate buyer at step S50 to the intermediary device 1.

Thus, even in the second example embodiment, when receiving the sales request information S1 which specifies the sales target data from the owner terminal 2, the intermediary device 1 can suitably notify the owner terminal 2 of the information regarding candidate buyer(s) expected to demand the sales target data.

### Third Example Embodiment

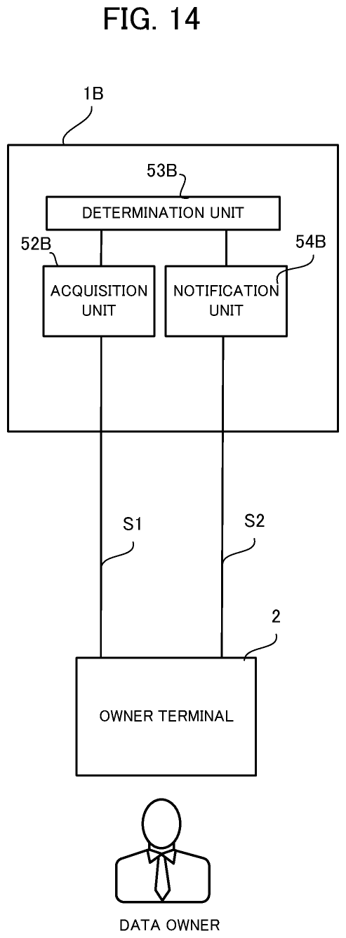

FIG. 14 is a functional block diagram of the intermediary device 1B according to the third example embodiment. The intermediary device 1B functionally includes an acquisition unit 52B, a determination unit 53B and a notification unit 54B.

The acquisition unit 52B acquires sales request information S1, which is request information regarding a sale of data owned by a data owner, from an owner terminal 2 used by the data owner. The determination unit 53B determines whether or not there is a user who has a past record of performing a task or who is expected to perform the task, the task being subjected to a positive effect when the data is used for the task. The notification unit 54B notifies, in a case where the determination unit 53B determines that there is a user who has a past record of performing the task or who is expected to perform the task, the owner terminal 2 of candidate buyer information S2 indicating information regarding the user.

Even according to the third example embodiment, the intermediary device 1B can also suitably notify the owner terminal 2 of the information regarding a candidate buyer expected to demand the sales target data provided by the owner terminal 2.

The whole or a part of the example embodiments described above (including modifications, the same applies hereinafter) can be described as, but not limited to, the following Supplementary Notes.

[Supplementary Note 1]

An intermediary device comprising:

an acquisition unit configured to acquire a request information regarding a sale of data owned by a data owner from an owner terminal used by the data owner;

a determination unit configured to determine whether or not there is a user who has a past record of performing a task or who is expected to perform the task, the task being subjected to a positive effect when the data is used for the task; and

a notification unit configured to notify, in a case where the determination unit determines that there is the user, the owner terminal of information regarding the user.

[Supplementary Note 2]

The intermediary device according to Supplementary Note 1,

wherein the information regarding the user includes information regarding the task and information regarding the positive effect.

[Supplementary Note 3]

The intermediary device according to Supplementary Note 2,

wherein the notification unit transmits display information as the information regarding the user to the owner terminal, the display information being used for displaying a list of the users in descending order of degree of the positive effect.

[Supplementary Note 4]

The intermediary device according to any one of Supplementary Notes 1 to 3,

wherein the determination unit makes the determination with reference to past record information which at least includes information regarding: data traded in the past; a task for which the data is used; and a user who traded the data.

[Supplementary Note 5]

The intermediary device according to Supplementary Note 4,

wherein the notification unit transmits display information as the information regarding the user to the owner terminal, the display information being used for displaying a list of the users in descending order of the number of past records of usage according to the past record information.

[Supplementary Note 6]

The intermediary device according to any one of Supplementary Notes 1 to 3,

wherein the determination unit makes the determination with reference to user information which at least includes information regarding a planned task and owned data.

[Supplementary Note 7]

The intermediary device according to Supplementary Note 6,

wherein, after the acquisition unit acquires the request information, the determination unit makes the determination based on the user information which is received from a user terminal used by the user.

[Supplementary Note 8]

A control method executed by an intermediary device, the control method comprising:

acquiring a request information regarding a sale of data owned by a data owner from an owner terminal used by the data owner;

determining whether or not there is a user who has a past record of performing a task or who is expected to perform the task, the task being subjected to a positive effect when the data is used for the task; and

notifying, in a case where it is determined that there is the user, the owner terminal of information regarding the user.

[Supplementary Note 9]

A storage medium storing a program executed by a computer, the program causing the computer to function as:

an acquisition unit configured to acquire a request information regarding a sale of data owned by a data owner from an owner terminal used by the data owner;

a determination unit configured to determine whether or not there is a user who has a past record of performing a task or who is expected to perform the task, the task being subjected to a positive effect when the data is used for the task; and

a notification unit configured to notify, in a case where the determination unit determines that there is the user, the owner terminal of information regarding the user.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent Literatures mentioned in this specification are incorporated by reference in its entirety.

### DESCRIPTION OF REFERENCE NUMERALS

1, 1A, 1B Intermediary device
2 Owner terminal
3 User terminal
21,31 Input unit
22,32 Output unit
13, 23, 33 Storage unit
14, 24, 34 Communication unit
15, 25, 35 Control unit
100 Data market system

What is claimed is:

1. An intermediary device comprising a processor configured to:
acquire a request information regarding a sale of data owned by a data owner from an owner terminal used by the data owner;
determine whether or not there is a user who has a past record of performing a task or who is expected to perform the task, the task being subjected to a positive effect when the data is used for the task; and
notify, in a case where it is determined that there is the user, the owner terminal of information regarding the user.

2. The intermediary device according to claim 1,
wherein the information regarding the user includes information regarding the task and information regarding the positive effect.

3. The intermediary device according to claim 2,
wherein the processor transmits display information as the information regarding the user to the owner terminal, the display information being used for displaying a list of the users in descending order of degree of the positive effect.

4. The intermediary device according to claim 1,
wherein the processor makes the determination with reference to past record information which at least includes information regarding: data traded in the past; a task for which the data is used; and a user who traded the data.

5. The intermediary device according to claim 4,
wherein the processor transmits display information as the information regarding the user to the owner terminal, the display information being used for displaying a list of the users in descending order of the number of past records of usage according to the past record information.

6. The intermediary device according to claim 1,
wherein the processor makes the determination with reference to user information which at least includes information regarding a planned task and owned data.

7. The intermediary device according to claim 6,
wherein, after acquiring the request information, the processor makes the determination based on the user information which is received from a user terminal used by the user.

8. A control method executed by an intermediary device, the control method comprising:
acquiring a request information regarding a sale of data owned by a data owner from an owner terminal used by the data owner;
determining whether or not there is a user who has a past record of performing a task or who is expected to perform the task, the task being subjected to a positive effect when the data is used for the task; and
notifying, in a case where it is determined that there is the user, the owner terminal of information regarding the user.

9. A non-transitory computer-readable storage medium storing a program executed by a computer, the program causing the computer to:
acquire a request information regarding a sale of data owned by a data owner from an owner terminal used by the data owner;
determine whether or not there is a user who has a past record of performing a task or who is expected to perform the task, the task being subjected to a positive effect when the data is used for the task; and
notify, in a case where it is determined that there is the user, the owner terminal of information regarding the user.
